(19) United States
(12) Patent Application Publication
(10) Pub. No.: US 2025/0292751 A1
(43) Pub. Date: Sep. 18, 2025

(54) MUSIC PERFORMING APPARATUS AND METHOD, AND RECORDING MEDIUM

(71) Applicant: CASIO COMPUTER CO., LTD., Tokyo (JP)

(72) Inventor: Daisuke OKIZAWA, Tokyo (JP)

(73) Assignee: CASIO COMPUTER CO., LTD., Tokyo (JP)

(21) Appl. No.: 19/072,634

(22) Filed: Mar. 6, 2025

(30) Foreign Application Priority Data
Mar. 18, 2024 (JP) 2024-041798

(51) Int. Cl. G10H 1/00; G10H 1/46

(52) U.S. Cl. CPC G10H 1/0008; G10H 1/46; G10H 2210/066; G10H 2210/081; G10H 2210/571

(57) ABSTRACT

A music performing apparatus includes a plurality of musical operation elements and at least one processor. In a case where a musical action on a musical operation element is detected, at least one processor determines whether a first sound pitch corresponding to the musical action is a sound pitch of a chord structural note in a tune in progress. In a case where the first sound pitch is not the sound pitch of the chord structural note, the at least one processor sequentially emits at least a musical sound of the first sound pitch and a musical sound of a second sound pitch that is the chord structural note in the tune.

### CROSS-REFERENCE TO RELATED APPLICATIONS

This application claims the benefit of Japanese Patent Application No. 2024-041798, filed on Mar. 18, 2024, the entire disclosure of which is incorporated by reference herein.

### BACKGROUND

### 1. Technical Field

The present disclosure relates to a music performing apparatus and method, and a recording medium.

### 2. Related Art

A music performing apparatus that assists a user who is not good at playing a musical instrument in music performance is known. For example, JP 2004-206073 A discloses a specific configuration of this type of music performing apparatus.

The music performing apparatus disclosed in JP 2004-206073 A uses a chord correspondence conversion table, to automatically converts a sound that is input by a user operation into a sound pitch matching a chord, and emit the sound. Further, the music performing apparatus controls sound generation so that a note that does not match the accompaniment or the like being reproduced at the same time is not sounded.

### SUMMARY

An embodiment of the present disclosure is advantageous in providing a music performing apparatus and method, and a program that facilitate a user to recognize that the user has performed an inappropriate musical action.

A music performing apparatus according to an embodiment of the present disclosure includes a plurality of musical operation elements and at least one processor. In a case where a musical action on a musical operation element is detected, at least one processor determines whether a first sound pitch corresponding to the musical action is a sound pitch of a chord structural note in a tune in progress. In a case where the first sound pitch is not the sound pitch of the chord structural note, the at least one processor sequentially emits at least a musical sound of the first sound pitch and a musical sound of a second sound pitch that is the chord structural note in the tune.

### BRIEF DESCRIPTION OF THE DRAWINGS

FIG. 1 is a block diagram illustrating the configuration of an electronic musical instrument according to an embodiment of the present disclosure;

FIG. 2 is a diagram illustrating part of a musical score corresponding to music data stored in an electronic musical instrument in an embodiment of the present disclosure;

FIG. 3 is a diagram for illustratively explaining a musical sound to be generated by an electronic musical instrument in an embodiment of the present disclosure;

FIG. 4 is a diagram for illustratively explaining a musical sound to be generated by an electronic musical instrument in an embodiment of the present disclosure;

FIG. 5 is a functional block diagram illustrating functions of an electronic musical instrument at the time of a key press action;

FIG. 6 is a flowchart showing processes to be performed by the processor of an electronic musical instrument in an embodiment of the present disclosure;

FIG. 7 is a subroutine of a musical action process in step S105 in FIG. 6;

FIG. 8 is a subroutine of a passing tone emission process shown in the flowchart in FIG. 6; and

FIG. 9 is a diagram illustrating information stored in a buffer of an electronic musical instrument according to an embodiment of the present disclosure.

### DETAILED DESCRIPTION

The following description relates to a music performing apparatus and method, and a program according to an embodiment of the present disclosure. Common or corresponding elements are denoted by the same or similar reference signs, and repetitive explanation is simplified or omitted as appropriate.

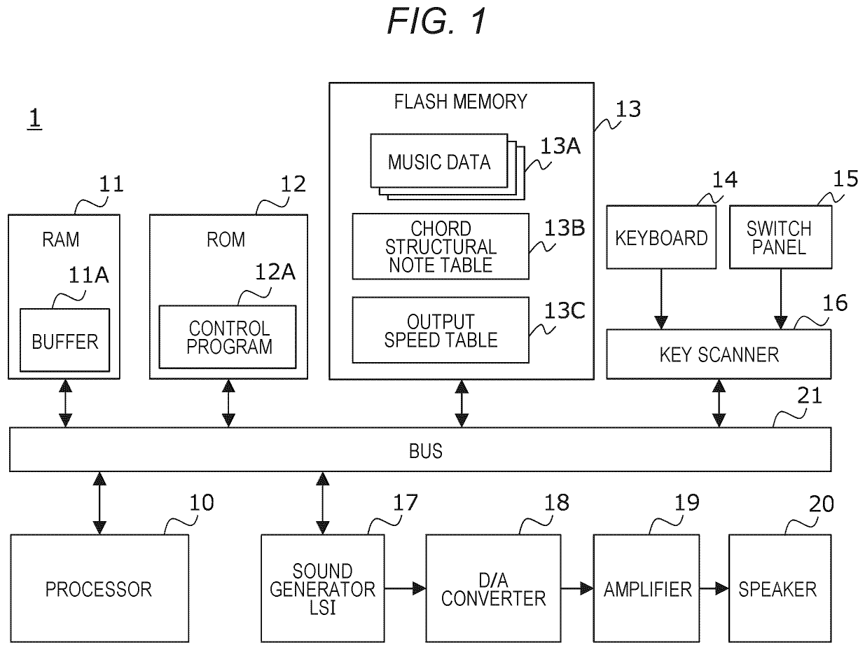

An electronic musical instrument 1 illustrated in FIG. 1 is an example of a music performing apparatus, and is an electronic keyboard, for example. The electronic musical instrument 1 may be an electronic keyboard instrument other than an electronic keyboard, such as an electronic piano. The electronic musical instrument 1 may be an electronic musical instrument in another form, such as an electronic percussion instrument, an electronic wind instrument, or an electronic string instrument.

The electronic musical instrument 1 is a computer, and includes, as hardware components, a processor 10, a random access memory (RAM) 11, a read only memory (ROM) 12, a flash memory 13, a keyboard 14, a switch panel 15, a key scanner 16, a large scale integration (sound generator LSI) 17, a D/A converter 18, an amplifier 19, and a speaker 20. The respective components of the electronic musical instrument 1 are connected by a bus 21.

The processor 10 reads a program and data stored in the ROM 12. The processor 10 comprehensively controls the electronic musical instrument 1, using the RAM 11 as a work area.

The processor 10 is a single-processor or a multiprocessor, for example, and includes at least one processor. In the case of a configuration including a plurality of processors, the processor 10 may be packaged as a single device, or may be formed with a plurality of devices physically separated in the electronic musical instrument 1. The processor 10 may also be referred to as a control unit, a central processing unit (CPU), a micro processor unit (MPU), or a micro controller unit (MCU), for example.

The RAM 11 temporarily holds data and programs. The RAM 11 holds various programs read from the ROM 12 and various kinds of data such as waveform data. Part of the memory area in the RAM 11 is ensured as a buffer 11A. As described later in detail, the buffer 11A stores information indicating a correspondence relationship between pressed-key note numbers and sounded note numbers. For convenience, the note number associated with a pressed key is shown as a “pressed-key note number”. The note number associated with a released key is shown as a “released-key note number”. The note number of a sounded musical note is shown as a “sounded note number”.

The ROM 12 stores a control program 12A. As the processor 10 executes the control program 12A, various processes according to an embodiment of the present disclosure are performed.

The flash memory 13 stores a plurality of pieces of music data 13A. Note that the plurality of pieces of music data 13A is pieces of data of different pieces of music, but the same reference sign 13A is given for convenience. The music data 13A is created in a Standard MIDI File (SMF) format, for example. The music data 13A includes a plurality of events. Delta times, command types, command data, and the like are written in the events.

The processor 10 sequentially reads the events in the music data 13A, and causes the music to progress according to the delta times written in the respective events. The music data 13A includes accompaniment data. The music data 13A including the accompaniment data can also be referred to as chord progression data. The music data 13A is not limited to data stored in the flash memory 13. The music data 13A can be acquired from an external terminal such as a universal serial bus (USB) memory, and can also be acquired from a server in a network.

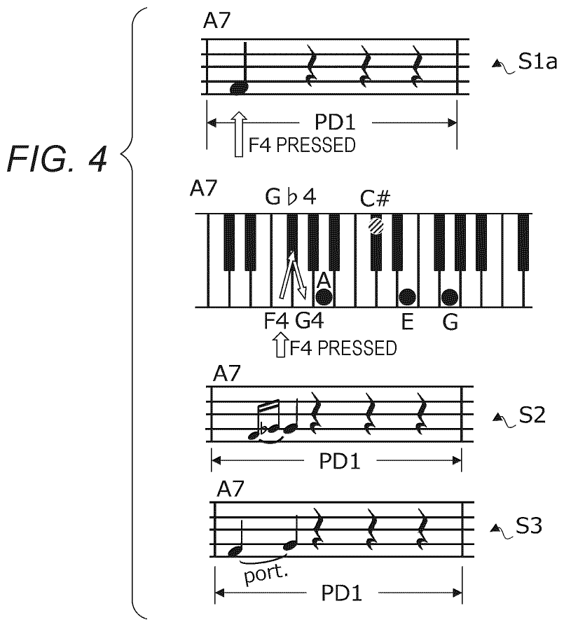

The flash memory 13 stores a chord structural note table 13B. In the chord structural note table 13B, chords and the structural notes thereof are associated are registered. For example, the chord A7 is associated with musical note names A, C♯, E, and G (or musical note numbers 9, 1, 4, and 7) as chord structural notes, and is registered together with the musical note names. For convenience, circles are added to the chord structural notes of the chord A7 on the keyboard shown in FIGS. 3 and 4.

The flash memory 13 stores an output speed table 13C. The output speed table 13C is a table for determining a note value when a passing tone to be described later is emitted.

The keyboard 14 includes eighty-eight keys that are musical operation elements. Specifically, the keyboard 14 includes fifty-two white keys and thirty-six black keys. Each key is associated with a different sound pitch. The electronic musical instrument 1 sounds a musical note in accordance with a key press action on a key included in the keyboard 14. The number of keys of the keyboard 14 is not necessarily eighty-eight. The keyboard 14 may be designed to include some other number of keys, such as sixty-one keys and seventy-six keys.

The switch panel 15 includes various operation elements for operating the electronic musical instrument 1. The various operation elements include a power button, a record button, and a play/stop button. The various operation elements also include operation elements for adjusting parameters such as volume and tone.

The key scanner 16 monitors key pressing and key release on the keyboard 14. When a key press action by a user is detected, for example, the key scanner 16 outputs a key press event to the processor 10. The key press event includes information (the key number) about the sound pitch of the key related to the key press action. A key number may also be referred to as a key number, a Musical Instrument Digital Interface (MIDI) key, or a note number. A sound pitch is sometimes called a note.

In the present embodiment, a means to measure a key press velocity is separately provided, and a velocity measured by this means is also included in a key press event. In an example, a plurality of contact switches is provided for each key. A velocity is measured from a difference in time in which each contact switch becomes conductive when a key is pressed. It is safe to say that the velocity is a value indicating the strength of the key press action, or is a value indicating the magnitude (volume) of the musical sound. Note that an electronic musical instrument 1 not having a velocity detection function is also included in embodiments according to the present disclosure.

Waveform data is stored in the ROM 12 or some other memory (not shown). The waveform data is loaded into the RAM 11 at the time of an activation process of the electronic musical instrument 1 so that musical notes are promptly sounded in response to key press actions. When the key scanner 16 detects a key press action, the processor 10 instructs the sound generator LSI 17 to read the corresponding waveform data from the waveform data loaded into the RAM 11. The waveform data to be read is determined from the tone and the key press event selected by the user's operation, for example.

The sound generator LSI 17 generates a musical sound on the basis of the waveform data read from the RAM 11, under the instruction of the processor 10. The sound generator LSI 17 includes 128 generator sections, and can simultaneously generate up to 128 musical sounds. Note that, in the present embodiment, the processor 10 and the sound generator LSI 17 are designed as separate processors. In another embodiment, however, the processor 10 and the sound generator LSI 17 may be designed as a single processor.

The digital musical sound data generated by the sound generator LSI 17 is converted into an analog signal by the D/A converter 18, is then amplified by the amplifier 19, and is output to the speaker 20.

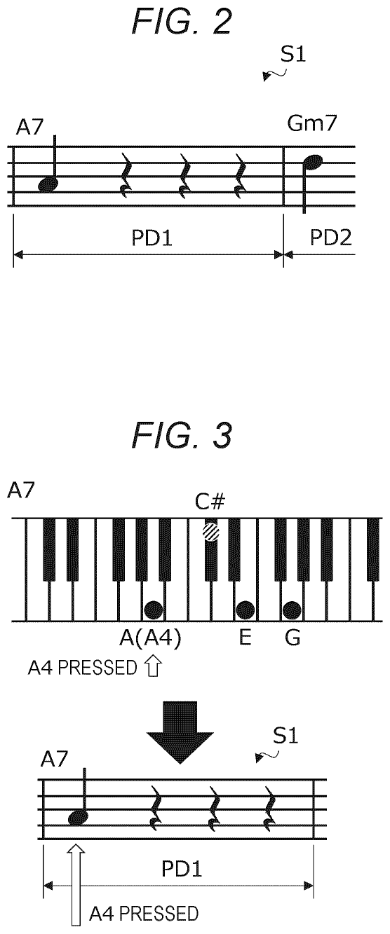

FIG. 2 illustrates part of a musical score S1 corresponding to the music data 13A. As illustrated in FIG. 2, the musical score S1 includes a melody and an accompaniment. The melody is expressed by a score, and the accompaniment is expressed by chords on the score. For convenience, the section of the bar with the chord A7 is referred to as the section PD1. The section of the bar with the chord Gm7 is referred to as the section PD2.

In the present embodiment, the processor 10 sequentially reads the events in the music data 13A corresponding to the musical score S1, and automatically performs progression of the chords (accompaniment) attached to the music in accordance with the delta time written in each event. Additionally, in accordance with the delta time written in each event, the processor 10 can determine to which section the current time belongs (in other words, which chord is to be sounded in the section). The user can play the melody to the accompaniment that is automatically played.

Here, in a conventional performance assisting apparatus, when the user presses an inappropriate key (a key of a sound pitch that is hardly appropriate in musical terms), the sound pitch is converted into a musically appropriate sound pitch inside the apparatus, and a musical sound is then emitted. Therefore, it is difficult for the user to recognize that the user has performed an inappropriate musical action.

Also, in the conventional performance assisting apparatus, movement of the user's fingers and the musical sounds to be emitted are not in coordination with each other. For example, a case where the user sequentially plays “B” and “C”, instead of “D” and “D” in the melody of a tune, is now discussed (for convenience, this case is referred to as the “performance example A”). In the performance example A, the same musical sound (“D” as a correct sound) is emitted twice, even though the user moves his/her fingers from “B” to “C”. Since the same musical sound is emitted even though the fingers are moved to press different keys, the user sometimes have a feeling of strangeness.

In view of this, when an inappropriate musical action is performed, the electronic musical instrument 1 according to the present embodiment emits a musical sound while changing the sound pitch stepwise or continuously from the sound pitch corresponding to the musical action (a sound pitch that is hardly appropriate in musical terms) to the sound pitch that is appropriate in musical terms. In the present embodiment, a musical sound that changes stepwise or continuously in this manner is referred to as a “passing tone”. In the present embodiment, a passing tone is a sound like an ornament close to an after note or a double appoggiatura.

In the present embodiment, the musical sound corresponding to a key pressed by the user is emitted, and thus, the performing feeling of the user is not to be impaired. Also, at the time of a musical action, a musical sound that is hardly appropriate in musical terms is emitted first, and thus, the user can easily recognize that the user has performed an inappropriate musical action. It is also easy for the user to recognize that the user has performed an inappropriate musical action, because musical sounds that are connected stepwise or continuously are emitted immediately after a musical sound that is hardly appropriate in musical terms is emitted. As a result, musically appropriate musical sounds are emitted (in other words, the chord structural notes are sounded so that there will be no feeling of strangeness with the chords in the tune in progress). Thus, a melody without unnaturalness in musical terms is obtained.

A case where the user uses the electronic musical instrument 1 according to the present embodiment, and sequentially plays “B” and “C”, instead of “D” and “D” in the melody of a tune, as in the above performance example A, is now discussed. In this case, “A, C, D, bD” or “C, D, bD” are emitted in this order. That is, after a musical sound that is hardly appropriate in musical terms is first emitted, the sound pitch changes toward the correct sound “D”. In this example, the sound pitch changes a half step at a time. As the musical sound to be emitted in response to a key press action changes, coordination between the movement of the user's fingers and the musical sounds is ensured. Accordingly, the user is less likely to have a feeling of strangeness.

By recognizing that the user has performed an inappropriate musical action, the user can correct the performance, and increase the user's own performance level.

Furthermore, the user can enjoy playing music.

In another point of view, the user can intentionally perform an inappropriate musical action, to change the sound pitch of the musical sound to be emitted stepwise or continuously. That is, the user can use the electronic musical instrument 1 to perform a new musical rendition in which the sound pitch is changed throughout the tune.

When musical sounds are emitted while the sound pitch is changed stepwise, a passing tone that changes in a chromatic manner (a half step at a time) is reproduced. When the sound pitch is changed in a chromatic manner, a passing tone that sounds comfortable to the ear is likely to be generated.

When musical sounds are emitted while the sound pitch is changed continuously, a smoother passing tone (a performance imitating the portamento performance) is reproduced. Note that, to electrically generate musical sounds, the sound pitch changes at the pitch corresponding to the minimum resolution with which musical sounds can be emitted (or in a stepwise manner). That is, the sound pitch changes stepwise in units that are small enough to be regarded as substantially stepless. In view of this, a continuous change in sound pitch in the electronic musical instrument 1 can also be accurately described as a stepwise change.

In a tone of a musical instrument with which a sound pitch is designated by a finger, such as a piano, a harmonica, or a saxophone, a musical sound is easily heard as a natural sound when the musical sound is emitted with a passing tone that changes stepwise. In a tone of a musical instrument with which the sound pitch is steplessly changed, such as a trombone or a guitar, even if musical sounds are emitted with a continuously changing passing tone, the musical sounds are natural.

Referring now to FIGS. 3 and 4, examples of musical sounds to be emitted by the electronic musical instrument 1 are described. In the example in FIG. 3, the key of the sound pitch A4 is pressed in the section PD1. The sound pitch A4 is a structural note of the chord A7. Accordingly, the sound pitch A4 is a musically appropriate sound pitch in the section PD1. Therefore, in the example in FIG. 3, the sound pitch A4 corresponding to the key pressed by the user is emitted as it is.

In the example in FIG. 4, the key of the sound pitch F4 is pressed in the section PD1. The sound pitch F4 is not a structural note of the chord A7. Therefore, the sound pitch F4 is hardly an appropriate sound pitch in musical terms in the section PD1. In view of this, in the example in FIG. 4, musical sounds are emitted while the sound pitch is changed from the sound pitch F4 to the sound pitch G4 in a chromatic manner (see a musical score S2). Alternatively, musical sounds are emitted while the sound pitch is changed continuously (at a finer pitch) from the sound pitch F4 to the sound pitch G4 (see a musical score S3). The sound pitch G4 is a structural note of the chord A7. As the sound pitch G4, which is a chord structural note, is emitted at last, a melody without unnaturalness in musical terms is obtained.

In FIG. 4, reference sign Sla indicates a musical score in a case where the sound pitch F4 is pressed in the section PD1. As can be seen from a comparison between the musical score Sla and the musical score S2 (or the musical score S3), a single key is simply pressed (a single-note action) in the present embodiment, to generate a passing tone in which the musical sound changes stepwise or continuously.

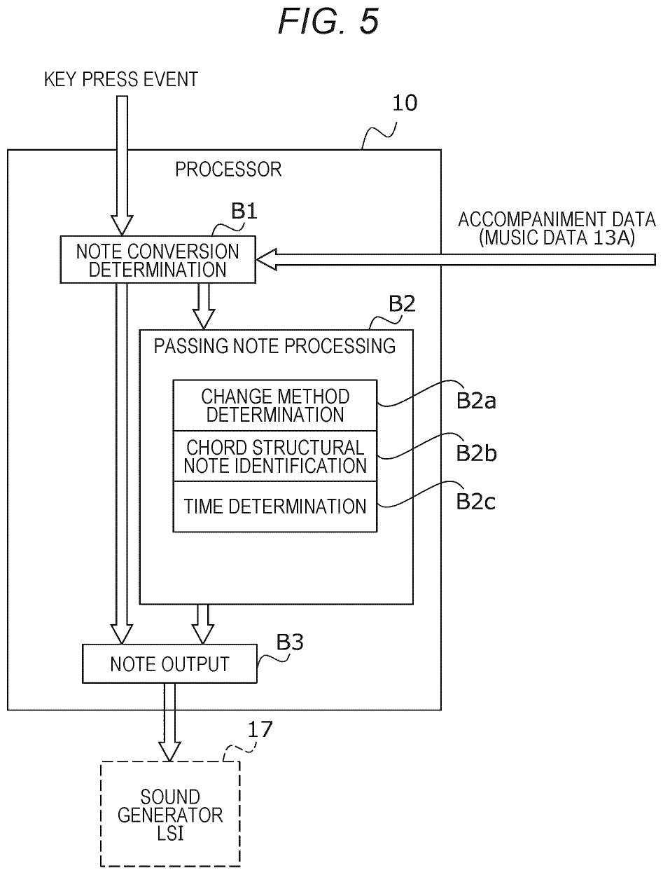

As shown in a functional block diagram in FIG. 5, the music data 13A, which is accompaniment data, is input to the processor 10. The processor 10 automatically performs chord progression (accompaniment) in accordance with the music data 13A.

When a key press event occurs, the note is input to the processor 10. The processor 10 performs note conversion determination (see reference sign B1).

Specifically, the processor 10 refers to the chord structural note table 13B, to identify the chord structural notes of the tune in progress. The processor 10 determines whether the note of the key press event is included in the sound pitches of the identified chord structural notes.

In a case where the note of the key press event is included in the sound pitches of the chord structural notes of the tune in progress, the processor 10 performs a note output (see reference sign B3). Specifically, the processor 10 instructs the sound generator LSI 17 to emit the musical sound at the sound pitch corresponding to the key pressed by the user.

In a case where the note of the key press event is not included in the sound pitches of the chord structural notes of the tune in progress, the processor 10 performs passing tone processing (see reference sign B2). Specifically, the processor 10 performs change method determination (see reference sign B2a), chord structural note identification (see reference sign B2b), and time determination (see reference sign B2c). In the change method determination B2a, whether the change in the musical sound is stepwise or continuous is determined. The change in the musical sound is determined, depending on the tone that has been set, for example. For example, in a case where the tone is set to that of the piano, the change method is determined to be a stepwise change. For example, in a case where the tone is set to that of the guitar, the change method is determined to be a continuous change.

The changing method may be determined depending on genre information (classical music, jazz, or the like) included in the music data 13A. Alternatively, information about the change method may be included beforehand in the music data 13A. That is, the change method may be determined beforehand for each tune.

In the chord structural note identification B2b, the chord structural note to be sounded at the end of the passing tone (the musical sound that changes stepwise or continuously) is identified. For example, among the chord structural notes of the tune in progress, the chord structural note that is higher than the sound pitch of the key pressed by the user and is closest to the sound pitch is identified. As shown in the example in FIG. 4, the chord structural note G4 that is higher than the sound pitch F4 of the key pressed by the user and is closest to the sound pitch F4 is identified.

In acoustic instruments, many transitions are in an ascending form. Also, a sound in an ascending form is more likely to be comfortable to the ear. As the passing tone is changed in an ascending form, a chord structural note that is higher than the sound pitch of the key pressed by the user is identified among the chord structural notes of the tune in progress. In another embodiment, among the chord structural notes of the tune in progress, the chord structural note that is higher than the sound pitch of the key pressed by the user and is n-th closest (n being 2 or greater) to the sound pitch may be identified. Note that the “passing tone” is a sound from the sound pitch of the key pressed by the user to the sound pitch of the chord structural note identified as above.

For some people, a sound in a descending form sounds more comfortable. In other words, each person has his/her own sensitivity to music. Therefore, the chord structural note to be identified as above is not necessarily the “chord structural note that is higher than the sound pitch of the key pressed by the user and is closest to the sound pitch”. In a case where the passing tone is changed in a descending form, the chord structural note that is lower than the sound pitch of the key pressed by the user and is m-th closest (m being 1 or greater) to the sound pitch may be identified among the chord structural notes of the tune in progress. In the example in FIG. 4, the chord structural note E4 that is lower than the sound pitch F4 of the key pressed by the user and is closest to the sound pitch F4 may be identified.

In the time determination B2c, the note value of the passing tone or the sound emission time of the entire passing tone is determined. Specifically, in a case where the passing tone is changed stepwise, the note value of the passing tone is determined to be a predetermined note value. Information about the predetermined note value is stored in the flash memory 13 (the output speed table 13C, for example). The note value of the passing tone is determined to have an appropriate length (about 1/30 seconds to 1/120 seconds, for example) so that the length of the passing tone falls within a range without strangeness. In a case where the passing tone is continuously changed, the sound emission time of the entire passing tone is determined to be a predetermined time.

In the time determination B2c, the predetermined note value (or the sound emission time of the entire passing tone) is read from the output speed table 13C, and is determined to be the note value of each passing tone (or the sound emission time of the entire passing tone).

In another embodiment, the note value of the passing tone may be determined on the basis of the performance conditions. In a case where the passing tone is changed stepwise, the passing tone is formed with the sounds of the respective half steps from the sound pitch of the key pressed by the user to the sound pitch of the chord structural note. As an example, a case where the sound pitch of the key pressed by the user is B♭4, and the sound pitch of the chord structural note is C♯4 is considered. In this case, each of the sounds of the sound pitches B♭4, B4, C4, and C♯4 is a passing tone.

In another embodiment, note values are associated with the respective performance conditions (tempo, for example) for a passing tone that changes stepwise and are registered in the output speed table 13C. For example, the note value of a 32nd note is registered for a tempo lower than 120. For example, the note value of a 128th notes is registered for a tempo equal to or higher than 120. In the time determination B2c, in the case of passing tones that change stepwise, the note value corresponding to the tempo specified by the music data 13A is read from the output speed table 13C, and is determined to be the note value of each passing tone.

When the note value of each passing tone is shortened, the entire time to be required until the chord structural note is generated from the musical sound corresponding to the key pressed by the user is also shortened. Accordingly, the note value of each passing tone is made shorter as the tempo becomes faster. In this manner, it is possible to finish generating the passing tone before the timing of playing of the next melody sound in any tune at any tempo.

Further, in another embodiment, sound emission times of the entire passing tone are associated with the respective performance conditions (tempo, for example) for a passing tone that changes continuously and are registered in the output speed table 13C. In the time determination B2c, in the case of passing tones that change continuously, the sound emission time corresponding to the tempo specified by the music data 13A is read from the output speed table 13C, and is determined to be the sound emission time of the entire passing tone.

In the case of a passing tone that changes continuously, the passing tone from the sound pitch of the key pressed by the user to the sound pitch of the chord structural note is emitted in the determined sound emission time. The sound emission time of the passing tone is made shorter as the tempo becomes faster. In this manner, it is possible to finish generating the passing tone before the timing of playing of the next melody sound in any tune at any tempo, as in the case of a passing tone that changes stepwise.

After finishing the passing tone processing B2, the processor 10 performs a note output (see reference sign B3). Specifically, the processor 10 instructs the sound generator LSI 17 to emit a passing tone from the sound pitch of the key pressed by the user to the sound pitch of the chord structural note while changing the passing tone stepwise or continuously.

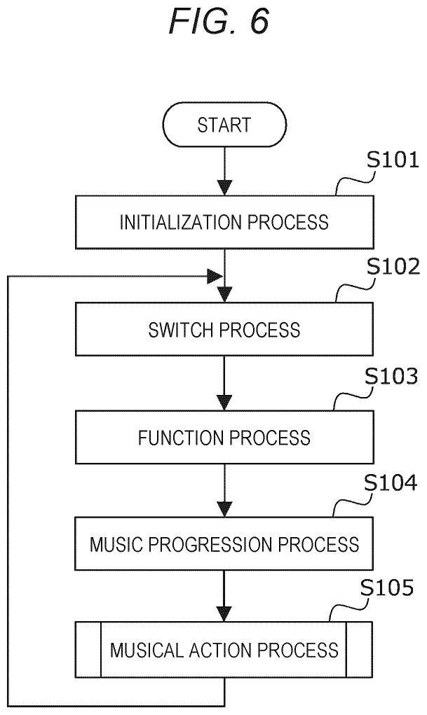

Referring now to FIG. 6, a flowchart of processes to be performed by the processor 10 in an embodiment of the present disclosure is described. For example, when the power supply to the electronic musical instrument 1 is switched on, execution of the processes shown in FIG. 6 is started.

Note that the order of the respective steps in the flowchart described in the present embodiment may be changed within a range without inconsistency. For example, although the present disclosure presents processes in various steps in an example order, the order is not limited to the presented order. Also, the respective steps in the flowchart described in the present embodiment may be carried out at the same time or in parallel within a range without inconsistency.

As shown in FIG. 6, the processor 10 performs an initialization process (step S101). In the initialization process, each component is initialized.

The processor 10 performs a switch process (step S102). In the switch process, operation states of various operation elements of the switch panel 15 are acquired. For example, information about volume, information about tone, an on/off state of an automatic harmonizing function to be described later, and the like are acquired.

The processor 10 performs a function process (step S103). In the function process, functions corresponding to the operation states of the various operation elements acquired in step S102 are executed.

For example, in a case where a play start button is pressed, a tune reproduction start process is executed. In a case where a music select button is pressed, the selected music data 13A is loaded from the flash memory 13 into the RAM 11. Also, the change method (whether to change the passing tone stepwise or continuously) is determined depending on to the set tone.

The processor 10 performs a music progression process (step S104). In the music progression process, the tune (the accompaniment in the present embodiment) progresses with the lapse of time (according to the delta time written in each event).

The processor 10 performs a musical action process (step S105). In the musical action process, a process corresponding to a musical action performed by the user is performed.

The processor 10 repeatedly performs the processes in steps S102 to S105 until the end of the reproduction of the tune is detected. For example, when the process proceeds to an event in which an end of track (EOT) command is written in the music data 13A, the processor 10 detects the end of the reproduction the tune, and ends the process shown in FIG. 6.

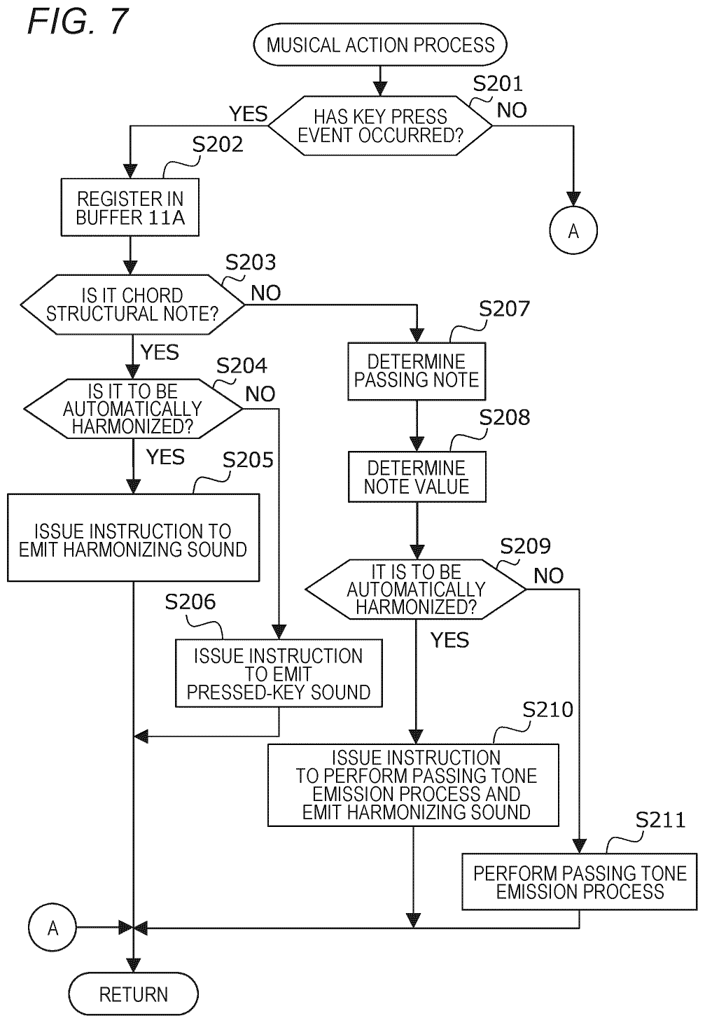

Referring now to FIG. 7, a subroutine of the musical action process (step S105 in FIG. 6) is described. As shown in FIG. 7, the processor 10 determines whether a key press event has occurred (step S201). If any key press event has not occurred (step S201: NO), the processor 10 ends the subroutine of the musical action process (step S105 in FIG. 6). If a key press event has occurred (step S201: YES), the processor 10 registers the pressed-key note number included in the key press event in the buffer 11A (step S202).

The processor 10 determines whether the sound pitch of the pressed-key note number registered in the buffer 11A is the sound pitch of a chord structural note in the tune in progress (step S203). The processor 10 can determine to which section the current time belongs, in accordance with the delta time written in each event. In other words, the processor 10 can identify the chord structural note to be the determination material in step S203, by determining which chord is to be sounded in the section.

After detecting a key press action (an example of a musical action) on a key (an example of a musical operation element) in this manner, the processor 10 determines whether the sound pitch of the pressed-key note number (an example of a first sound pitch corresponding to a key press action) is the sound pitch of a chord structural note in the tune in progress.

Note that any reference to elements with nominal designations such as “first” and “second” as used in the present disclosure does not generally limit the amounts or order of those elements. These designations are used for convenience to distinguish between two or more elements. Accordingly, reference to first and second elements does not mean that only the two elements are adopted, that the first element must precede the second element, or the like.

If the sound pitch of the pressed-key note number is the sound pitch of the chord structural note in the tune in progress (step S203: YES), the processor 10 determines whether the automatic harmonizing function is in an ON state (step S204).

The automatic harmonizing function is a function of sounding a chord even in a case where the user presses a single note. For example, in the automatic harmonizing function, a chord having the single note pressed by the user as the highest chord structural note is sounded.

The user can switch on and off the automatic harmonizing function by operating the switch panel 15. Also, the user can make detailed settings such as setting a chord to be sounded by the automatic harmonizing function as a three-noted chord or a four-noted chord. To be distinguished from the accompaniment sound, a chord generated and sounded by the automatic harmonizing function is referred to as a “harmonizing sound”.

If the automatic harmonizing function is in an ON state (step S204: YES), the processor 10 instructs the sound generator LSI 17 to generate a harmonizing sound (step S205). The harmonizing sound to be generated here is a chord having the sound pitch of the pressed-key note number as the highest chord structural note. For example, in the case illustrated in FIG. 3, the user presses the key of the sound pitch A4 in the section PD1 while the automatic harmonizing function is in an ON state. In this case, a musical sound of the sound pitch A4 pressed by the user is emitted, and, at the same time, a musical sound with sound pitches (sound pitches E4 and C♯4, for example) included in the corresponding chord A7 in the section PD1 is emitted. As described above, even if the user presses a single note, the sound to be emitted is a chord (a harmonizing sound), and thus, a colorful performance is provided. As a result, the electronic musical instrument 1 emits a harmonizing sound in parallel with the automatically progressing accompaniment. Note that, at the time of the sound emission instruction, the processor 10 associates each sounded note number corresponding to the harmonizing sound with the pressed-key note number, and registers the sounded note numbers in the buffer 11A.

If the automatic harmonizing function is in an OFF state (step S204: NO), the processor 10 instructs the sound generator LSI 17 to emit a pressed-key sound (a musical sound of the pressed-key note number) (step S206). As a result, the electronic musical instrument 1 emits the pressed-key sound in parallel with the automatically progressing accompaniment.

After issuing the instruction to emit a harmonizing sound (step S205) or the instruction to emit a key-pressed sound (step S206), the processor 10 ends the subroutine of the musical action process (step S105 in FIG. 6). Although not shown in the flowchart, when a key release event occurs, the processor 10 searches the buffer 11A for the pressed-key note number that matches the released-key note number included in the key release event. The processor 10 deletes the pressed-key note number and the corresponding sounded note number found in the search from the buffer 11A, and instructs the sound generator LSI 17 to silence the musical sound of the sounded note number. As a result, the harmonizing sound and the key release sound are silenced.

As described above, in a case where the sound pitch of a pressed-key note number (an example of the first sound pitch) is a chord structural note in the tune being played, the electronic musical instrument 1 emits a musical sound of the pressed-key note number (or a harmonizing sound including the musical sound of the pressed-key note number). That is, the electronic musical instrument 1 emits the chord structural note corresponding to the key pressed by the user. Accordingly, a melody that does not give a feeling of strangeness with the chord of the tune in progress is provided.

If the sound pitch of the pressed-key note number is not the sound pitch of a chord structural note in the tune in progress (step S203: NO), the processor 10 determines the passing tone (chord structural note) to be emitted at last in response to the key press event (step S207).

In the example in FIG. 4, with respect to F4 (note number 65) included in the key press event, G4 (note number 67) as a chord structural note is determined to be the passing tone to be emitted at last. That is, in the present embodiment, on the premise that there are many users who prefer an ascending form, the chord structural note that is higher than the sound pitch of the pressed key and closest to the sound pitch among the chord structural notes in the tune in progress is determined to be the passing tone to be emitted at last in response to the key press event. For convenience, the sound pitch of the pressed-key note number that is included in a key press event and is not of a chord structural note is referred to as the “first passing tone”. The chord structural note to be emitted at last in response to the key press event is referred to as the “final passing tone”.

As described above, the sound pitch (an example of a second sound pitch) of the final passing tone is the sound pitch of the chord structural note that is higher than the sound pitch (an example of a first sound pitch) of the first passing tone and is closest to the sound pitch of the first passing tone among the sound pitches of the chord structural notes. In a case where the passing tone is to be moved in a descending form, the sound pitch of the final passing tone may be the sound pitch of the chord structural note that is lower than the sound pitch of the first passing tone and is closest to the sound pitch of the first passing tone among the sound pitches of the chord structural notes.

The processor 10 determines the note value of the passing tone (or the sound emission time of the entire passing tone) so that the sound emission from the first passing tone to the final passing tone is completed by the timing of playing of the next melody sound (step S208). Specifically, as described above, the processor 10 determines the note value of each passing tone to be a predetermined length. Also, as described above, the processor 10 determines the sound emission time of the entire passing tone to be a predetermined length.

In this manner, the processor 10 determines the note value of the respective emission target musical sounds from the sound pitch (an example of the first sound pitch) of the first passing tone to the sound pitch (an example of the second sound pitch) of the final passing tone, to be a predetermined length. Also, the processor 10 determines the time (the sound emission time of the entire passing tone) required from the first passing tone (an example of a musical sound with the first sound pitch) until the sound emission of the final passing tone (an example of a musical sound with the second sound pitch) to be a predetermined length.

The processor 10 determines whether the automatic harmonizing function is in an ON state (step S209). If the automatic harmonizing function is in an ON state (step S209: YES), the processor 10 sequentially instructs the sound generator LSI 17 to emit the sounds starting from the first passing tone until the final passing tone, and instructs the sound generator LSI 17 to continuously emit the chord structural notes that are chord structural notes in the tune in progress but exclude the final passing tone (step S210).

Thus, the electronic musical instrument 1 sounds a chord (a harmonizing sound) while changing the sound stepwise or continuously from the first passing tone until the final passing tone, in parallel with the automatically progressing accompaniment. The passing tones (the passing tones in the order of F4, G♭4, and G4) in the musical score S2 are now described as an example. In this case, a musical sound of the sound pitch F4 pressed by the user is emitted, and, at the same time, chord structural notes included in the corresponding chord A7 in the section PD1 are sounded. The chord structural notes of the chord A7 to be sounded at the same time as the passing tone F4 are chord structural notes that are lower than the musical sound of the sound pitch F4 as a passing tone and are not the final passing tone G4, and are the sound pitches E4 and C♯4, for example. Successively, a chord structural note of the chord A7 is emitted simultaneously with the musical sound of the sound pitch G♭4, and lastly, a chord structural note of the chord A7 is emitted simultaneously with the musical sound of the sound pitch G. As described above, even if the user presses a single note, a passing tone is emitted as a harmonizing sound, and thus, a colorful melody is provided. Note that the passing tone is the highest sound in the harmonizing sound. Further, the chord structural note to be emitted simultaneously with each passing tone may be always the same (the sound pitches E4 and C♯4), or may be different for each passing tone.

If the automatic harmonizing function is in an OFF state (step S209: NO), the processor 10 sequentially instructs the sound generator LSI 17 to emit the sounds from the first passing tone to the final passing tone (step S211). Thus, the electronic musical instrument 1 sounds a passing tone that is changed stepwise or continuously from the first passing tone until the final passing tone, in parallel with the automatically progressing accompaniment.

After issuing the instruction to emit the sound (step S210 or S211), the processor 10 ends the subroutine of the musical action process (step S105 in FIG. 6).

As described above, in a case where the first passing tone (an example of the first sound pitch) is not the sound pitch of the chord structural note, the electronic musical instrument 1 emits sound while changing the sound pitch stepwise or continuously from the sound pitch of the first passing tone to the sound pitch (an example of the second sound pitch) of the final passing tone.

In the example in which the passing tone is changed stepwise in FIG. 4, when the key of G♭4 is pressed, the passing tones are the two of G♭4 (the first passing tone) and G4 (the final passing tone). Therefore, this can also be described as “in a case where the first passing tone (an example of the first sound pitch) is not the sound pitch of a chord structural note, the electronic musical instrument 1 emits at least the first passing tone (an example of the musical sound of the first sound pitch) and the final passing tone (an example of the musical sound of the second sound pitch) in this order”.

Note that the final passing tone (an example of the musical sound of the second sound pitch) may be emitted at a higher velocity (or a larger volume) than those of the passing tones other than the final passing tone. In the example in FIG. 4, the passing tones not included in the chord A7 are emitted small, and the chord structural notes included in the chord A7 are emitted large, so that a clear passing tone with less strangeness is heard.

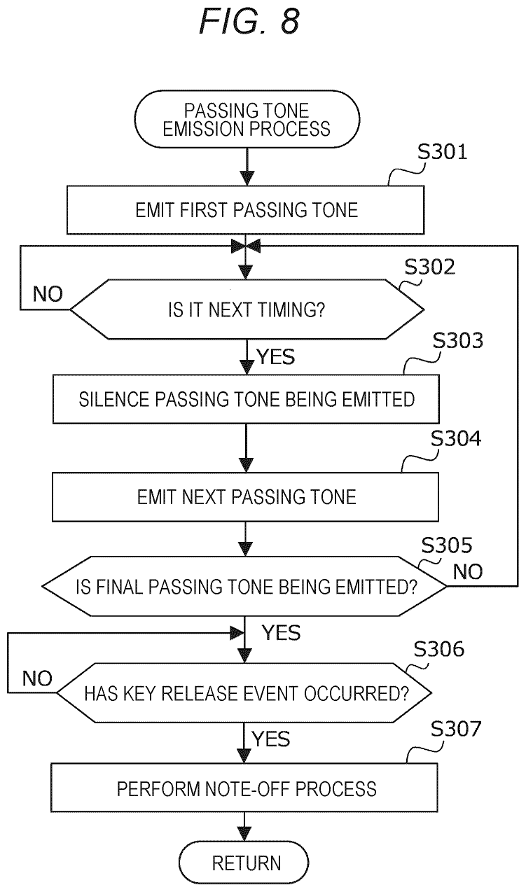

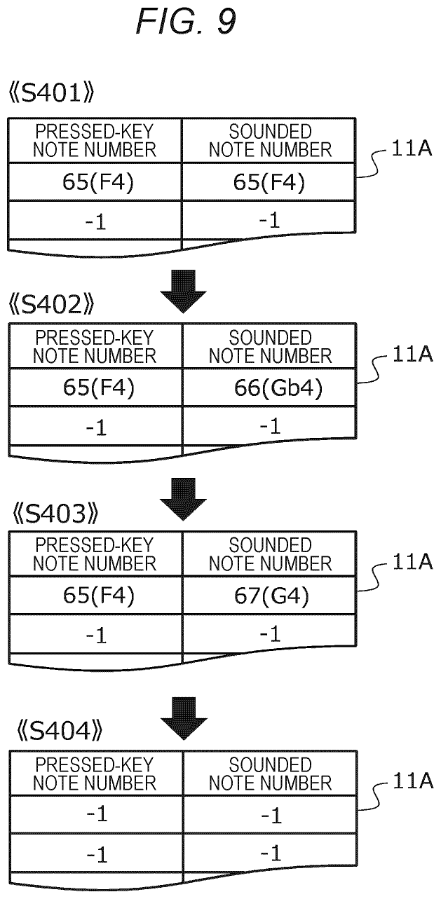

Referring now to FIGS. 8 and 9, a subroutine of the passing tone emission process included in steps S210 and S211 in FIG. 7 is described. Here, an example in which the passing tone is changed stepwise is described.

As shown in FIG. 8, in the passing tone emission process, the processor 10 instructs the sound generator LSI 17 to emit the first passing tone (step S301). The first passing tone is the musical sound of the sound pitch F4 corresponding to the pressed-key note number 65, for example. At the time of the instruction to emit the first passing tone, the processor 10 registers the value 65 in the buffer 11A as the sounded note number of the first passing tone (see reference sign S401 in FIG. 9).

In the buffer 11A, a plurality of sets of a pressed-key note number and a sounded note number can be registered so that musical sounds corresponding to the respective key press actions can be simultaneously emitted when a plurality of keys is simultaneously pressed. In the buffer 11A, a value −1 indicating an invalid state is stored in an empty element.

The processor 10 determines whether it is the timing of emission of the next passing tone (step S302). In a case where the time corresponding to the note value determined in step S208 in FIG. 7 has elapsed since the point of time at which the emission of the passing tone being emission was started, the timing of emission of the next passing tone has already come. In this case (step S302: YES), the processor 10 instructs the sound generator LSI 17 to silence the passing tone being emitted (step S303), and instructs the sound generator LSI 17 to emit the next passing tone (step S304).

Additionally, the processor 10 deletes, from the buffer 11A, the sounded note number of the passing tone being emitted, and registers the sounded note number of the next passing tone in the buffer 11A. In the example with reference sign S402 in FIG. 9, the sounded note number 65 (F4) of the first passing tone is deleted, and the sounded note number 66 (G♭4) of the next passing tone is registered in the buffer 11A. In the example with reference sign S403 in FIG. 9, the sounded note number 66 (G♭4) of the first passing tone is deleted, and the sounded note number 67 (G4) of the final passing tone is registered in the buffer 11A.

The processor 10 determines whether the final passing tone is being emitted (step S305). If the final passing tone is not being emitted (step S305: NO), the processor 10 repeats the processes in steps S302 to S305. If the final passing tone is being emitted (step S305: YES), the processor 10 determines whether a key release event has occurred (step S306).

If the occurrence of a key release event is detected (step S306: YES), the processor 10 performs a note-off process (step S307), and ends the subroutine of the passing tone emission process. Specifically, the processor 10 searches the buffer 11A for a pressed-key note number that matches the released-key note number included in the key release event. The processor 10 deletes the pressed-key note number and the corresponding sounded note number found in the search from the buffer 11A (see reference sign S404 in FIG. 9), and instructs the sound generator LSI 17 to silence the musical sound (or the final passing tone) of the sounded note number. As a result, the final passing tone is silenced.

If the occurrence of a key release event is not detected (step S306: NO), the processor 10 does not instruct the sound generator LSI 17 to silence the final passing tone. Therefore, the final passing tone continues to sound.

In the passing tone emission process shown in FIG. 8, the note-off process is not performed until the final passing tone is emitted. That is, in a case where a passing tone is to be emitted (in other words, in a case where the first passing tone (an example of the first sound pitch) is not the sound pitch of a chord structural note), sounds are emitted sequentially until the final passing tone (an example of the second sound pitch), regardless of whether a key release action is to be performed (or whether the musical action is to be turned off). As the final passing tone, which is a chord structural note, is emitted at last, a melody without unnaturalness in musical terms is obtained.

In another embodiment, the passing tone may be silenced immediately when a key release event occurs, regardless of whether the final passing tone is being emitted. In an example in FIG. 9, when a key release event is detected during emission of a passing tone of the sounded note number 66 (G♭4), the processor 10 instructs the sound generator LSI 17 to silence the passing tone at that time, and deletes the pressed-key note number 65 (F4) and the sounded note number 66 (G♭4) from the buffer 11A. That is, the passing tone comes to an end, without emission of a musical sound of the sounded note number 67 (G4), which is the final passing tone. Since the passing tone is silenced immediately after the key release action, there is less strangeness as an operating feeling of the user.

According to the present embodiment, the musical sound corresponding to a key pressed by the user is emitted, and thus, the performing feeling of the user is not to be impaired. Also, at the time of a musical action, a musical sound that is hardly appropriate in musical terms is emitted first, and thus, the user can easily recognize that the user has performed an inappropriate musical action. It is also easy for the user to recognize that the user has performed an inappropriate musical action, because musical sounds that are connected stepwise or continuously are emitted immediately after a musical sound that is hardly appropriate in musical terms is emitted. As a result, musically appropriate musical sounds are emitted (in other words, the chord structural notes are sounded so that there will be no feeling of strangeness with the chords in the tune in progress). Thus, a melody without unnaturalness in musical terms is obtained. In the present disclosure, the phrase “at least” includes a plurality of combinations or a number equal to or greater than an indicated number so that “at least one of A, B, and C” means “(A), (B), (C), (A and B), (A and C), (B and C), or (A, B and C)”, for example, unless otherwise stated. Furthermore, in a case where there is a plurality of Cs, for example, the phrase “at least one of A, B, and C” means “(A), (B), (at least one C), (A and B), (A and at least one C), (B and at least one C), or (A, B, and at least one C)”. A plurality of As or a plurality of Bs is also to be handled in the same manner as described above.

Exemplary embodiments of the present disclosure have been described so far. Embodiments of the present disclosure are not limited to those described above, and various modifications can be made within the scope of the technical idea of the present disclosure. For example, embodiments of the present application also include contents obtained by appropriately combining the embodiments and the like illustratively described in the specification or obvious embodiments and the like.

What is claimed is:

1. A music performing apparatus comprising:
a plurality of musical operation elements; and
at least one processor,
wherein the at least one processor is configured to:
in a case where a musical action on the musical operation element is detected, determine whether a first sound pitch corresponding to the musical action is a sound pitch of a chord structural note in a tune in progress; and,
in a case where the first sound pitch is not the sound pitch of the chord structural note, sequentially emit at least a musical sound of the first sound pitch and a musical sound of a second sound pitch that is the chord structural note in the tune.

2. The music performing apparatus according to claim 1, wherein the at least one processor is further configured to,
in a case where the first sound pitch is not the sound pitch of the chord structural note, emit sound while changing the sound stepwise or continuously from the first sound pitch to the second sound pitch.

3. The music performing apparatus according to claim 1, wherein the second sound pitch is a sound pitch of a structural note that is higher than the first sound pitch and is closest to the first sound pitch, among sound pitches of the chord structural note.

4. The music performing apparatus according to claim 1, wherein the at least one processor is further configured to
determine a note value of each of emission target musical sounds in accordance with a tempo of the tune, the emission target musical sounds being sounds from the first sound pitch to the second sound pitch.

5. The music performing apparatus according to claim 1, wherein the at least one processor is further configured to
emit the musical sound of the second sound pitch at a higher volume than musical sounds of other sound pitches, among the respective emission target musical sounds from the first sound pitch to the second sound pitch.

6. The music performing apparatus according to claim 1, wherein the at least one processor is further configured to,
in a case where the first sound pitch is not the sound pitch of the chord structural note, sequentially emit sounds until the second sound pitch, regardless of whether the musical action is to be turned off.

7. The music performing apparatus according to claim 1, wherein the at least one processor is further configured to,
in a case where the first sound pitch is the sound pitch of the chord structural note, emit the musical sound of the first sound pitch.

8. A method for causing a computer to:
in a case where a musical action on a musical operation element of a music performing apparatus is detected, determine whether a first sound pitch corresponding to the musical action is a sound pitch of a chord structural note in a tune in progress; and,
in a case where the first sound pitch is not the sound pitch of the chord structural note, issue an instruction to sequentially emit at least a musical sound of the first sound pitch and a musical sound of a second sound pitch that is the chord structural note in the tune.

9. The method according to claim 8, wherein, in a case where the first sound pitch is not the sound pitch of the chord structural note, sound is emitted while being changed stepwise or continuously from the first sound pitch to the second sound pitch.

10. The method according to claim 8, wherein the second sound pitch is a sound pitch of a structural note that is higher than the first sound pitch and is closest to the first sound pitch, among sound pitches of the chord structural note.

11. The method according to claim 8, wherein a note value of each of emission target musical sounds is determined in accordance with a tempo of the tune, the emission target musical sounds being sounds from the first sound pitch to the second sound pitch.

12. The method according to claim 8, wherein the musical sound of the second sound pitch is emitted at a higher volume than musical sounds of other sound pitches, among the respective emission target musical sounds from the first sound pitch to the second sound pitch.

13. The method according to claim 8, wherein, in a case where the first sound pitch is not the sound pitch of the chord structural note, sound is emitted until the second sound pitch, regardless of whether the musical action is to be turned off.

14. The method according to claim 8, wherein, in a case where the first sound pitch is the sound pitch of the chord structural note, the musical sound of the first sound pitch is emitted.

15. A non-transitory computer-readable recording medium storing a program for causing a computer to:
in a case where a musical action on a musical operation element of a music performing apparatus is detected, determine whether a first sound pitch corresponding to the musical action is a sound pitch of a chord structural note in a tune in progress; and,
in a case where the first sound pitch is not the sound pitch of the chord structural note, issue an instruction to sequentially emit at least a musical sound of the first sound pitch and a musical sound of a second sound pitch that is the chord structural note in the tune.
